(19) United States
(12) Patent Application Publication
(10) Pub. No.: US 2012/0052716 A1
(43) Pub. Date: Mar. 1, 2012

(54) WALL PLATE ASSEMBLY

(75) Inventors: CHEN-XI WANG, Kunshan (CN); HONG-QIANG HAN, Kunshan (CN); ZI-QIANG ZHU, Kunshan (CN)

(73) Assignee: HON HAI PRECISION INDUSTRY CO., LTD., New Taipei (TW)

(21) Appl. No.: 13/221,808

(22) Filed: Aug. 30, 2011

(30) Foreign Application Priority Data
Sep. 1, 2010 (CN) 201020513101.6

(51) Int. Cl. H01R 4/24; H01R 13/66

(52) U.S. Cl. 439/389; 439/536

(57) ABSTRACT

A wall plate assembly (100) includes a wall plate (20) having an opening (201) passing therethrough in a front-to-back direction, a connector (10) fixedly provided at a back side of said wall plate and corresponding to the opening for insertion of a plug, a spacer (4) assembled to the connector, and a plurality of electrical wires (30). The connector includes an insulative housing (1), and a set of contacts (2) disposed on the insulative housing and having contacting portions (21) for mating with the plug and tail portions (23) opposite to the contacting portions. The electrical wires (30) connect to the tail portions (23) of the contacts and are retained between the insulative housing (1) and the spacer (4).

### BACKGROUND OF THE INVENTION

1. Field of the Invention

The present invention relates to a wall plate assembly, and more particularly to a wall plate assembly having a connector attached to a wall plate.

2. Description of Related Art

At present, many types of high speed transmission connectors such as HDMI (High Definition Multimedia Interface), DisplayPort, or DiiVA (Digital Interactive Interface for Video & Audio) connectors are widely used as input/output interfaces adapted for many electronic devices, such as personal computer and related peripherals so as to transmit high quality audio and video signals. Disposition of these electronic devices in house requires extra spaces and extending the length of cables to provide a remote connection of these electronic devices. However, it is neither beautiful nor safe to directly arrange the cables outside of the walls, the floor or the ceiling of the house.

Hence, a wall plate assembly is desired to overcome the above problems.

### BRIEF SUMMARY OF THE INVENTION

According to one aspect of the present invention, a wall plate assembly comprises: a wall plate defining an opening passing therethrough in a front-to-back direction, a connector fixedly provided at a back side of said wall plate and corresponding to the opening for insertion of a plug, a spacer assembled to the insulative housing, and a plurality of electrical wires. The connector comprises an insulative housing, and a plurality of contacts disposed on the insulative housing and having contacting portions for mating with the plug and tail portions opposite to the contacting portions. The electrical wires connect to the tail portions of the contacts and are retained between the insulative housing and the spacer.

According to another aspect of the present invention, a wall plate assembly for being installed on a wall of a house comprises: a wall plate defining an opening passing therethrough in a front-to-back direction, a connector fixedly provided at a back side of said wall plate and corresponding with the opening for insertion of a plug, a plurality of electrical wires, and a spacer being assembled to the insulative housing for retaining the electrical wires. The connector comprises an insulative housing, a metal shell retained on the insulative housing and defining a receiving space corresponding to the opening for receiving the plug, and a plurality of contacts disposed on the insulative housing. The contacts have contacting portions arranged in one row and extending into the receiving space for mating with the plug, and tail portions extending beyond the insulative housing and arranged in two rows in an upper-to-lower direction. Each of the tail portion has a pair of branched clamping portions. The electrical wires each has a mating section clamped between the corresponding clamping portions of the tail portion and an extending section for extending into the wall of the house.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a wall plate assembly according to an embodiment of the present invention;

FIG. 2 is a perspective view of the wall plate assembly with a wall plate removed therefrom;

FIG. 3 is a partially exploded view of the FIG. 2;

FIG. 4 is similar to FIG. 3, but viewed from another aspect;

FIG. 5 is an exploded view the wall plate assembly shown in FIG. 2;

FIG. 6 is similar to FIG. 5, but viewed from another aspect; and

FIG. 7 is a cross-sectional view taken along line 7-7 of the FIG. 2.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details.

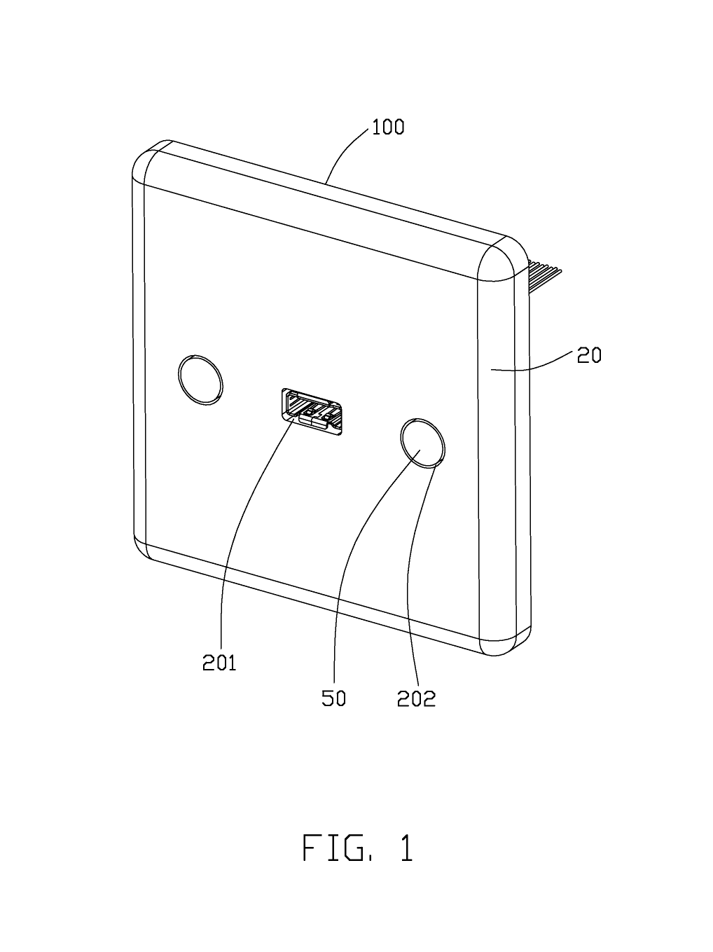

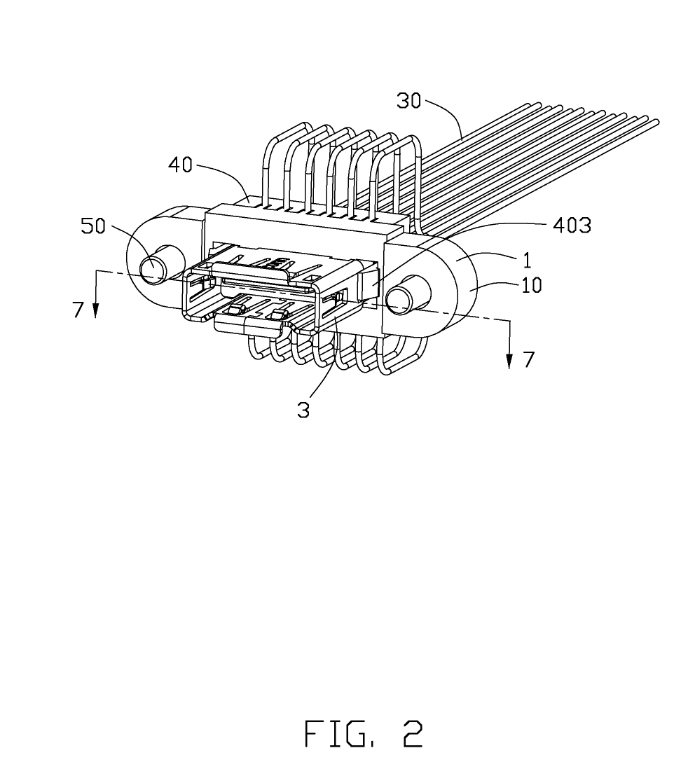

Referring to FIGS. 1 and 2, a wall plate assembly 100 according to an embodiment of the present invention is provided for being installed on a wall, a ceiling or a floor of a house. The wall plate assembly 100 comprises a wall plate 20 having an opening 201 passing therethrough in a front-to-back direction, a connector 10 assembled to the wall plate 20 and corresponding to the opening 201, a plurality of electrical wires 30 for connecting the connector 10, a spacer 40 attached to the connector 10 and positioning the electrical wires 30, and two pairs of screws 50. The wall plate 20 has a pair of screw holes 202 formed thereon for one pair of screws 50 being assembled thereto so as to orientate the wall plate 20 onto the wall, ceiling or floor of the house.

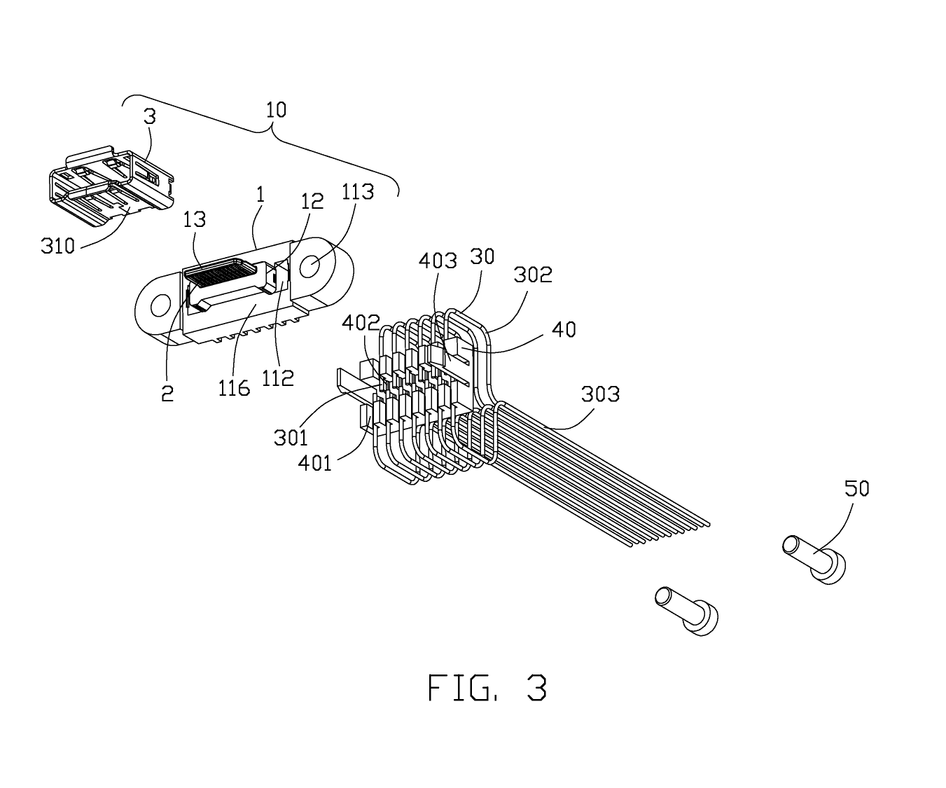

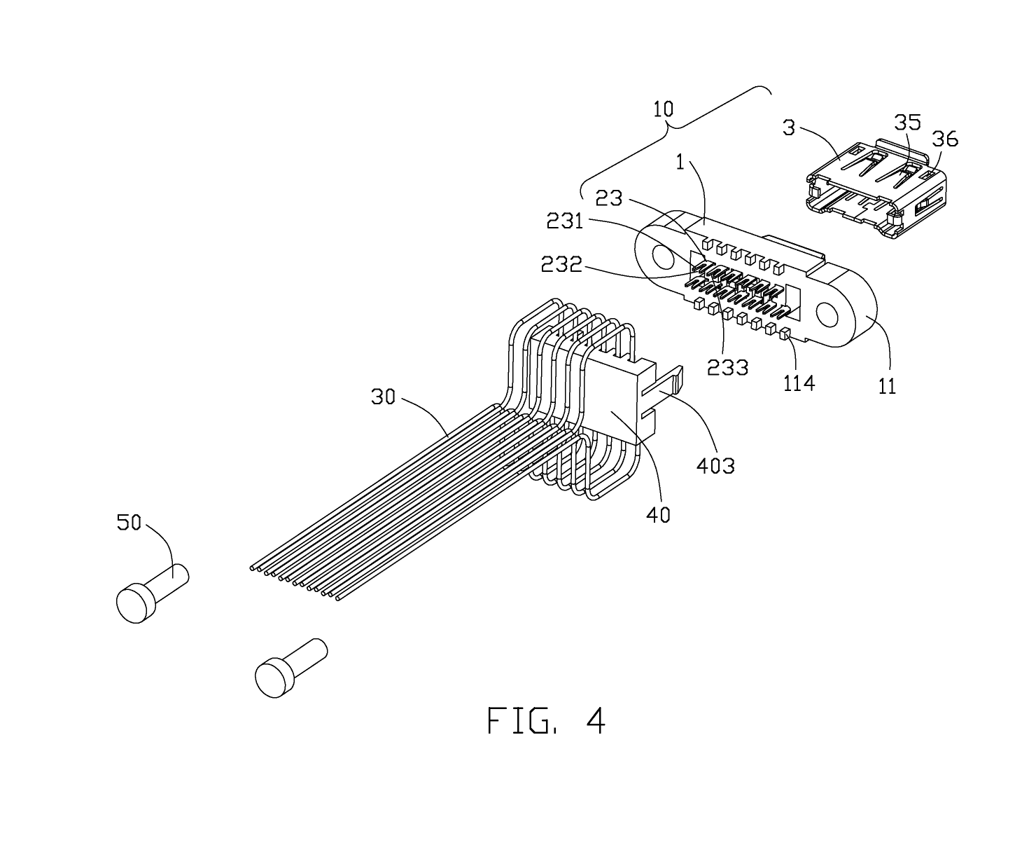

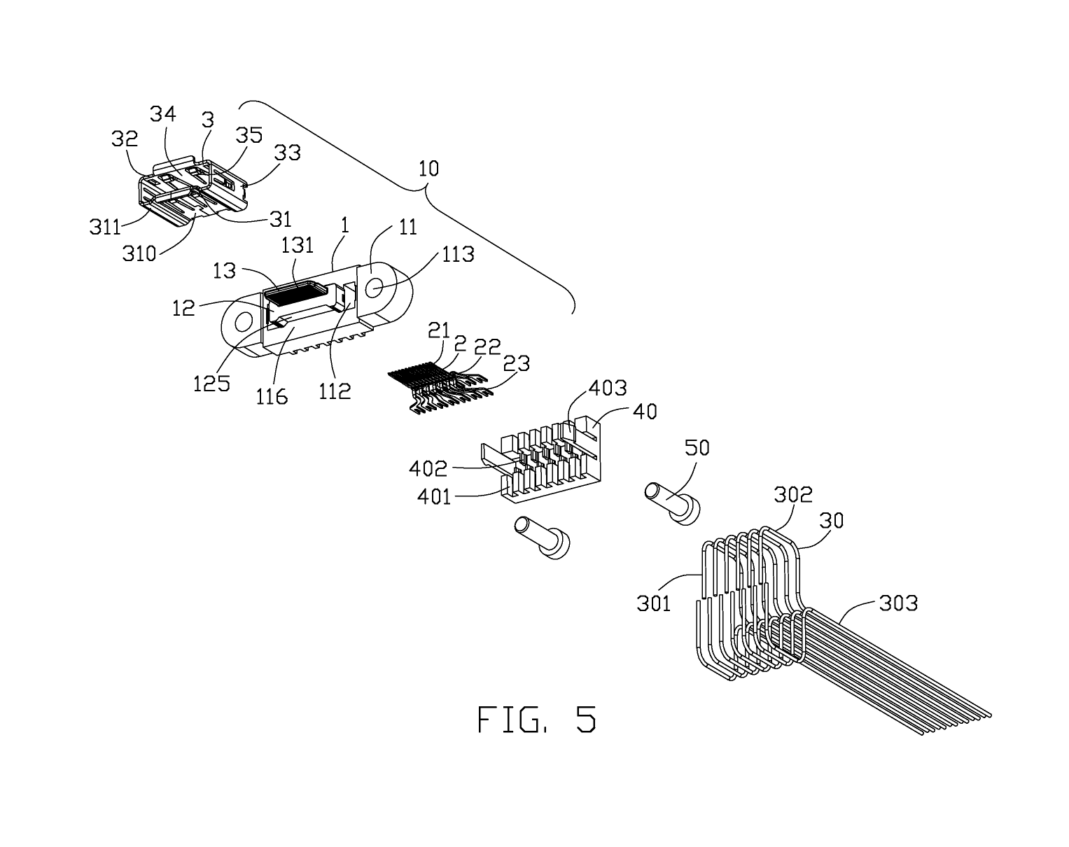

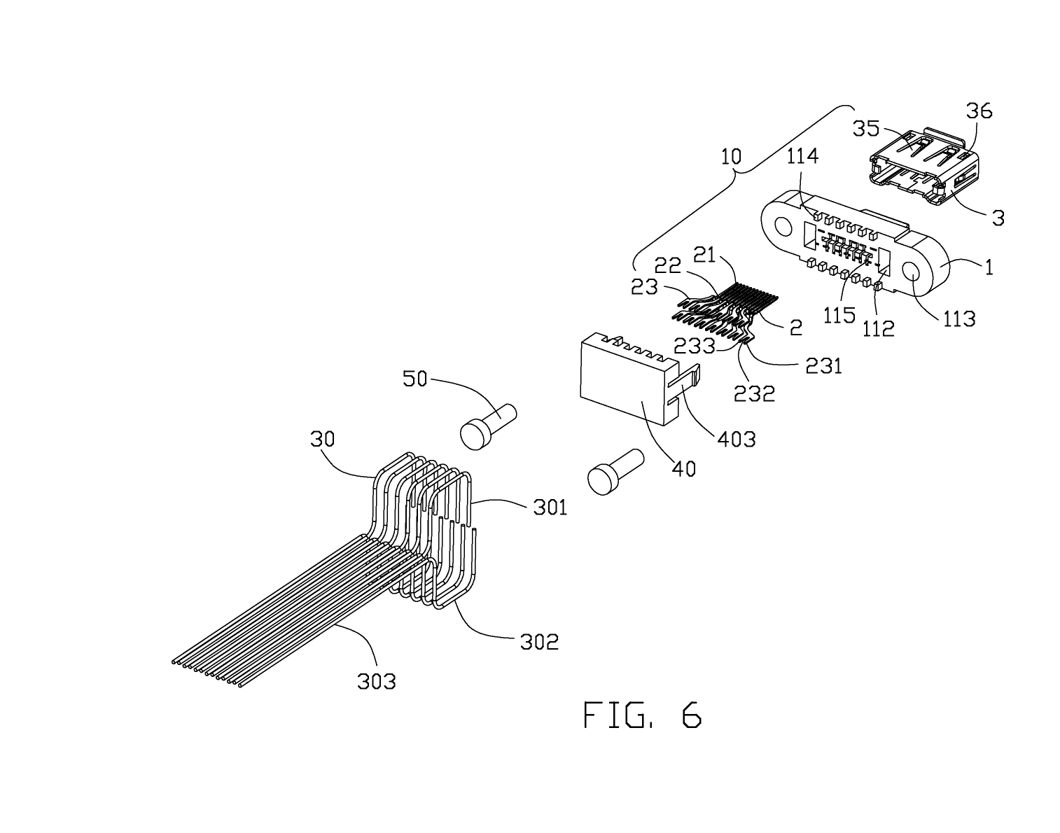

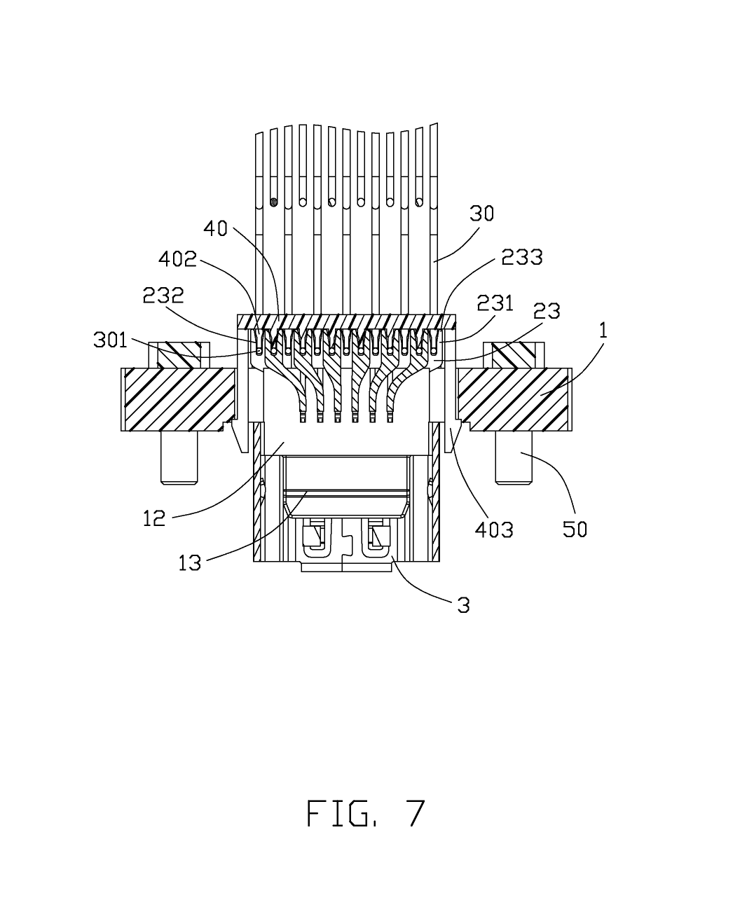

Referring to FIGS. 2-7, the connector 10 in this embodiment is a DiiVA (Digital Interactive Interface for Video & Audio) receptacle connector. it is also to be understood, in other embodiments, the connector 10 could be a HDMI (High Definition Multimedia Interface) receptacle connector, or a DisplayPort receptacle connector, or other connectors. The connector 10 includes an insulative housing 1, a plurality of contacts 2 disposed on the insulative housing 1 and a metal shell 3 assembled to the insulative housing 1.

The insulative housing 1 has a base 11, a body portion 12 extending forwardly from the base 11, and a tongue portion 13 extending forwardly from a front end of the body portion 12. The base 11 has a recess 116 recessed backwardly from a front face thereof, the body portion 12 is located in the recess 116 and protrudes forwardly beyond a front end of the base 11. A depression 125 is depressed upwardly from a lower face of the body portion 12. The tongue portion 13 has a plurality of passageways 131 defined on a bottom face thereof and arranged in one row along a transverse direction. The base 11 has a pair of slots 112 passing therethrough in the front-to-back direction and located at two lateral sides of the body portion 12, and a pair of through holes 113 passing therethrough in the front-to-back direction and located at two lateral sides of the recess 116 for another pair of screws 50 passing through so as to orientate the insulative housing 1 onto the wall plate 20. The base 11 has two rows of protrusions 114 protruding backwardly from upper and lower sides of a back face thereof, and two rows of retaining slots 115 arranged at two sides of the passageways 131 in an upper-to-lower direction and located between the two rows of protrusions 114.

The contacts 2 have contacting portions 21 arranged in one row and retained in the passageways 131, tail portions 23 extending backwardly beyond the insulative housing 1, and connecting portions 22 retained in the insulative housing 1 and connecting the contacting portions 21 and the tail portions 23. The tail portions 23 offset upwardly and downwardly in turns so as to be arranged in two rows along the upper-to-lower direction and retained in the retaining slots 115 respectively. The tail portions 23 in each row offset toward two lateral sides so as to increase the distance between each two adjacent tail portions 23 in the transverse direction, and each tail portion 23 could increase its width so as to form a pair of clamping portions 231 and a clamping slot 232 located between the clamping portions 231. Each clamping slot 232 has an expanding guiding slot 233 at a back end thereof for guiding the electrical wire 30 into the clamping slot 232. In this embodiment, the contacts 2 are assembled to the insulative housing 1, it is also to be understood, in other embodiments, the contacts 2 could be insert molded into the insulative housing 1.

The metal shell 3 is stamped and formed of conductive sheet metal materials. The metal shell 3 is retained around the body portion 12 and located between the two slots 112. The metal shell 3 has a planar top wall 32, a bottom wall 31 opposite to the top wall 32, a pair of side walls 33 connecting the top wall 32 and bottom wall 31, and a receiving space 34 surrounded by the top wall 32, the bottom wall 31 and the side walls 33 and corresponding to the opening 201 for receiving a plug connector (not shown). The tongue portion 13 and the contacting portions 21 are accommodated in the receiving space 34. In this embodiment, a front end of the metal shell 3 is located behind a front end of the opening 201, it is also to be understand, the front end of the metal shell 3 could be located at front of or aligned with the front end of the opening 201. The bottom wall 31 has a depressed wall 310 depressed upwardly toward the receiving space 34 so as to prevent the plug connector from mismating the connector 100, and a pair of connecting walls 311 connecting the side walls 33 and the depressed wall 310. The connecting walls 311 have a same width in the transverse direction and are parallel to the top wall 32. The depressed wall 310 is retained in the depression 125 of the body portion 12. Each of the top wall 32 and the depressed wall 310 has a pair of spring tabs 35 extending forwardly and protruding inwardly into the receiving space 34. The top wall 32 has a pair of perforations 36 at two lateral sides of the spring tabs 35 for being latched by the plug connector.

The electrical wires 30 have mating sections 301 for being received into the clamping slots 232 respectively and being clamped between the clamping portions 231 so as to connect to the tail portions 23, extending sections 303 for extending into the wall, ceiling or floor of the house, and conjunct sections 302 jointing the mating sections 301 and the extending sections 303. The conjunct sections 302 comprise a first row of conjunct sections 302 presenting as a U shape while viewed from a side elevation, and a second row of conjunct sections 302 presenting as a reversed U shape while viewed from the side elevation. The mating sections 301 which connect the first row of conjunct sections 302 connect to one row of the tail portions 23, the mating sections 301 which connect the second row of conjunct sections 302 connect to the other row of the tail portions 23. All of the extending sections 303 are arranged in a single row in the transverse direction.

The spacer 4 has a plurality of cavities 401 arranged in two rows along the upper-to-lower direction, and a plurality of ribs 402 arranged in two rows between the two rows of cavities 401. The ribs 402 which are arranged in an upper row align with an upper row of the cavities 401 respectively in the upper-to-lower direction, and the ribs 402 which are arranged in a lower row align with a lower row of the cavities 401 respectively along the upper-to-lower direction. When the spacer 40 is assembled to the insulative housing 1, the conjunct sections 302 pass through the cavities 401 respectively in the upper-to-lower direction, the protrusions 114 of the insulative housing 1 are received in the cavities 401 and resist the conjunct sections 302 backwardly into the cavities 401 so that the conjunct sections 302 are sandwiched between the insulative housing 1 and the spacer 40 firmly; the mating sections 301 are received into the clamping slots 232 respectively and clamped by the clamping portions 231, the ribs 402 of the spacer 40 are received in the clamping slots 232 and resist the mating sections 301 forwardly so that the mating sections 301 are retained into the clamping slots 232 firmly and electrically connect to the tail portions 23 of the contacts 2 reliably. The spacer 40 has a pair of resilient latching arms 403 protruding forwardly from two sides thereof. The latching arms 403 pass through the slots 112 and latch onto the recess 116 of the insulative housing 1 so as to orientate the spacer 40 onto the insulative housing 1. The metal shell 3 is retained between the two latching arms 403 in the transverse direction so as to prevent the metal shell 3 from vibrating in the transverse direction.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A wall plate assembly comprising:
a wall plate defining an opening passing therethrough in a front-to-back direction;
a connector fixedly provided at a back side of said wall plate and corresponding to the opening for insertion of a plug, the connector comprising an insulative housing; and a plurality of contacts disposed on the insulative housing and having contacting portions for mating with the plug and tail portions opposite to the contacting portions;
a spacer assembled to the insulative housing; and
a plurality of electrical wires connecting to the tail portions of the contacts and retained between the insulative housing and the spacer.

2. The wall plate assembly according to claim 1, wherein the insulative housing has a base for being fixed with the wall plate, a contractible body portion extending forwardly from the base, and a tongue portion extending forwardly from the body portion and supporting the contacting portions of the contacts.

3. The wall plate assembly according to claim 2, wherein the electrical wires have mating sections connecting to the contacting portions, extending sections opposite to the mating sections, and conjunct sections jointing the mating sections and the extending sections, the spacer has a plurality of cavities at a front side thereof for receiving the conjunct sections, the base has a plurality of protrusions protruding backwardly from a back face thereof to be received into the cavities and resist the conjunct sections into the corresponding cavities backwardly.

4. The wall plate assembly according to claim 3, wherein each tail portion of the contacts has a pair of clamping portions clamping the corresponding mating section therebetween, the spacer has a plurality of ribs protruding forwardly and located between the corresponding two clamping portions to resist the mating sections forwardly.

5. The wall plate assembly according to claim 3, wherein the contacting portions are arranged in one row on one side of the tongue portion, the tail portions offset upwardly and downwardly in turns so as to be arranged in two rows in an upper-to-lower direction.

6. The wall plate assembly according to claim 5, wherein the tail portions in each row offset toward two lateral sides so as to increase the distance between each two adjacent tail portions in a transverse direction.

7. The wall plate assembly according to claim 2, wherein the base has a recess recessed backwardly from a front face thereof, and a pair of slots recessed backwardly and passing through the base in the front-to-back direction, the body portion is located in the recess and between the two slots, the spacer has a pair of latching arms protruding forwardly and passing through the slots to latch onto the recess of the base.

8. The wall plate assembly according to claim 7, wherein the connector comprises a metal shell retained around the body portion and located between the two latching arms, the metal shell defines a receiving space for accommodating the tongue portion and the contacting portions and aligned with the opening of the wall plate and.

9. A wall plate assembly for being installed on a wall of a house comprising:
a wall plate defining an opening passing therethrough in a front-to-back direction;
a connector fixedly provided at a back side of said wall plate and corresponding with the opening for insertion of a plug, the connector comprising an insulative housing; a metal shell retained on the insulative housing and defining a receiving space corresponding to the opening for receiving the plug; and a plurality of contacts disposed on the insulative housing, the contacts having contacting portions arranged in one row and extending into the receiving space for mating with the plug; and tail portions extending beyond the insulative housing and arranged in two rows in an upper-to-lower direction, each of the tail portion having a pair of branched clamping portions;
a plurality of electrical wires each having a mating section clamped between the corresponding clamping portions of the tail portion and an extending section for extending into the wall of the house; and
a spacer being assembled to the insulative housing for retaining the electrical wires.

10. The wall plate assembly according to claim 9, wherein the spacer has two rows of ribs protruding forwardly and located between the corresponding two clamping portions to resist the mating sections forwardly.

11. The wall plate assembly according to claim 9, wherein the electrical wires have two rows of conjunct sections jointing the mating sections and the extending sections, while viewed from the transverse direction, the conjunct sections of one row presents as a U shape, and the conjunct sections of the other row present as a reversed U shape, the extending sections are arranged in a single row.

12. The wall plate assembly according to claim 11, wherein the spacer has two rows of cavities at a front side thereof for the conjunct sections passing through, the insulative housing has a plurality of protrusions protruding backwardly and received into the cavities to resist the conjunct sections into the cavities backwardly.

13. The wall plate assembly according to claim 9, wherein the insulative housing has a base for being fixed with the wall plate, a contractible body portion extending forwardly from the base, and a tongue portion extending forwardly from the body portion and into the receiving space to support the contacting portions of the contacts.

14. The wall plate assembly according to claim 13, wherein the base has a recess recessed backwardly from a front face thereof, and a pair of slots recessed backwardly from the recess and passing through the base in the front-to-back direction, the body portion is located in the recess and between the two slots, the spacer has a pair of latching arms protruding forwardly and passing through the slots to latch onto the recess of the base, the metal shell is retained around the body portion and located between the two latching arms.

15. The wall plate assembly according to claim 9, wherein the tail portions offset upwardly and downwardly in turns so as to be arranged in the two rows, and the tail portions in each row offset toward two lateral sides so as to increase the distance between each two adjacent tail portions in the transverse direction.

16. A connector assembly comprising:
an insulative housing defining a base with extension in all front-to-back direction, lengthwise direction and transverse direction perpendicular to one another, and further equipped with a body portion extending forwardly from the base and further equipped with a tongue portion extending forwardly from the body portion;
a plurality of contacts disposed in the housing, each of said contacts including a contacting section exposed upon the tongue portion and a tail portion located behind a rear side of the base with a clamping lance for IDC (Insulation Displacement Contact) under condition that said tail portions are arranged in two upper and lower rows each along the lengthwise direction with the clamping lances of the tail portions face rearwardly in the front-to-back direction;
an insulative spacer attached to a back side of the base and defining two upper and lower rows of cavities; and
one row of wires having front sections arranged in two upper and lower rows and approaching from upper and lower sides of the spacer and received in the corresponding upper and lower cavities, respectively, so as to have the clamping lances of the tail portions of the corresponding contacts pierce into the corresponding wires rearward in the front-to-back direction.

17. The connector assembly as claimed in claim 16, wherein said one row of wires are alternate arranged to be split into said two upper and lower rows on the corresponding front sections.

18. The connector assembly as claimed in claim 16, wherein each of said front sections defines a U-shaped configuration.

19. The connector assembly as claimed in claim 16, wherein said connector further includes a pair of ears located by two ends of the base in said lengthwise direction.

20. The connector assembly as claimed in claim 16, wherein the connector further includes a metallic shell defining a mating port, and the spacer defines a securing device located outside said mating port.
